(19) United States
(12) Patent Application Publication
(10) Pub. No.: US 2018/0252092 A1
(43) Pub. Date: Sep. 6, 2018

(54) SENSOR SYSTEM FOR BLOWOUT PREVENTER AND METHOD OF USE

(71) Applicant: General Electric Company, Schenectady, NY (US)

(72) Inventors: Yuri Alexeyevich Plotnikov, Niskayuna, NY (US); Cheng-Po Chen, Niskayuna, NY (US); Steven Klopman, Delanson, NY (US); Emad Andarawis Andarawis, Ballston Lake, NY (US); Gregory Jay Myers, Spring, TX (US)

(21) Appl. No.: 15/449,241

(22) Filed: Mar. 3, 2017

(51) Int. Cl. E21B 47/08; E21B 47/09; E21B 33/06; G01B 7/12

(52) U.S. Cl. CPC E21B 47/082; E21B 47/0905; E21B 33/064; G01B 7/12; E21B 33/063

(57) ABSTRACT

A sensor system for a sub-sea oil and gas well includes a casing, a transmit coil, a receive coil, and a processor. The casing defines an interior space through which a drilling pipe string transits. The transmit coil is coupled to the casing and is configured to conduct a current pulse and induce an electromagnetic field within the interior space. The electromagnetic field corresponds with the current pulse and interacts with the drilling pipe string. The receive coil is coupled to the casing and is configured to detect the electromagnetic field, including perturbations of the electromagnetic field due to the drilling pipe string's interaction therewith. The processor is coupled to the transmit coil and the receive coil. The processor is configured to compute a diameter of the drilling pipe string based on the current pulse and the electromagnetic field detected by the receive coil.

### STATEMENT REGARDING FEDERALLY SPONSORED RESEARCH AND DEVELOPMENT

This invention was made with Government support under contract number 11121-5503-01 awarded by the Department of Energy. The Government has certain rights in this invention.

### BACKGROUND

The field of the disclosure relates generally to blowout preventers and, more particularly, to a sensor system for determining position of pipe joints within a blowout preventer.

Sub-sea oil and gas production generally involves drilling and operating wells to locate and retrieve hydrocarbons. Rigs are positioned at well sites in relatively deep water. Tools, such as, for example, and without limitation, drilling tools, tubing, and pipes, are employed at these wells to explore submerged reservoirs. It is important to prevent spillage and leakage of fluids from the well into the environment. Well operators generally do their utmost to prevent spillage or leakage, however, the penetration of high-pressure reservoirs and formations during drilling can cause a sudden pressure increase, or “kick,” in the wellbore itself. A large pressure kick can result in a blowout of a drill pipe casing, drilling mud, and hydrocarbons from the wellbore, resulting in a malfunction of the well.

Blowout preventers are commonly used in drilling and completion of oil and gas wells to protect drilling and operational personnel, as well as the well site and its equipment, from the effects of a blowout. Generally, a blowout preventer is a remotely controlled valve or set of valves that can close off the wellbore in the event of an unanticipated increase in well pressure. Some known blowout preventers include several valves arranged in a stack surrounding the drill string. The valves within a given stack typically differ from one another in their manner of operation and in their pressure rating, thus providing varying degrees of well control. For example, many known blowout preventers include a valve of a blind shear ram type, which is configured to sever and crimp the drill pipe, serving as the ultimate emergency protection against a blowout if the other valves in the stack cannot control the well pressure.

During a blowout, when the valves of the blowout preventer are activated, the shear rams are expected to sever the drilling pipe string to prevent the blowout from affecting drilling equipment upstream. The shear rams are placed such that the drilling pipe string is severed from more than one side when the valves of the blowout preventer are actuated. The shear rams can fail to sever the drilling pipe string for various reasons, including, for example, and without limitation, lateral movement of the drilling pipe string inside the blowout preventer, and the presence of a pipe-joint in the proximity of the shear rams. Accordingly, it is desirable to know the position of the pipe joints with respect to the blowout preventer shear rams, and to know the nature of the drilling pipe string's movement during operation.

### BRIEF DESCRIPTION

In one aspect, a sensor system for a sub-sea oil and gas well is provided. The sensor system includes a casing, a transmit coil, a first receive coil, and a processor. The casing defines an interior space through which a drilling pipe string transits. The transmit coil is coupled to the casing and is configured to conduct a current pulse and induce an electromagnetic field within the interior space. The electromagnetic field corresponds with the current pulse and interacts with the drilling pipe string. The first receive coil is coupled to the casing and is configured to detect the electromagnetic field and perturbations of the electromagnetic field due to the drilling pipe string's interaction therewith. The processor is coupled to the transmit coil and the first receive coil. The processor is configured to compute a diameter of the drilling pipe string based on the current pulse and the electromagnetic field detected by the first receive coil.

In another aspect, a sub-sea blowout preventer is provided. The sub-sea blowout preventer includes a cylindrical casing, a communication interface, and a sensor system. The cylindrical casing defines an interior space through which a drilling pipe string transits. The communication interface is configured to be communicatively coupled to a drilling platform by a communication channel. The sensor system includes a transmit coil, a first receive coil, and a processor. The transmit coil is coupled to the cylindrical casing. The transmit coil is configured to periodically generate an electromagnetic field within the interior space and with which the drilling pipe string interacts. The first receive coil is coupled to the cylindrical casing. The first receive coil is configured to detect the electromagnetic field, including perturbations of the electromagnetic field due to the drilling pipe string's interaction therewith. The processor is coupled to the communication interface, the transmit coil, and the first receive coil. The processor is configured to track a diameter of the drilling pipe string based on the electromagnetic field detected by the first receive coil, and transmit data representing the diameter onto the communication channel through the communication interface.

In yet another aspect, a method of operating a sensor system at a sub-sea oil and gas well is provided. The method includes generating a current pulse. The method includes conducting the current pulse through a transmit coil to induce an electromagnetic field within an interior space of a casing of the sensor system. The method includes detecting, at a first receive coil, the electromagnetic field, including perturbations of the electromagnetic field due to the drilling pipe string's interaction with the electromagnetic field as it transits through the casing. The method includes computing a diameter of the drilling pipe string based on the electromagnetic field detected by the first receive coil.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic side view of an exemplary sub-sea oil and gas well that includes a blowout preventer;

FIG. 2 is a schematic side view of an exemplary sensor system for use in the sub-sea oil and gas well shown in FIG. 1;

FIG. 3 is a schematic side view of an exemplary arrangement of sensor coils shown in FIG. 2;

FIG. 4 is a schematic side view of an alternative arrangement of sensor coils shown in FIG. 2;

FIG. 5 is a schematic side view of another alternative arrangement of sensor coils shown in FIG. 2;

FIG. 6 is a schematic diagram of the sensor system shown in FIG. 2;

FIG. 7 is a plot of voltage and current over time for the sensor system shown in FIGS. 2 and 6;

FIG. 8 is a schematic cross-sectional view of an alternative embodiment of the sensor system shown in FIGS. 2 and 6; and

FIG. 9 is a flow diagram of an exemplary method of operating the sensor system shown in FIGS. 2 and 6.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the terms processor, processing device, and controller.

In the embodiments described herein, memory may include, but is not limited to, a computer-readable medium, such as a random access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Embodiments of the present disclosure relate to sub-sea blowout preventers and, more specifically, a sensor system for detecting and tracking drilling pipe joints for a sub-sea oil and gas well. The sensor systems described herein may be embodied within a blowout preventer, a blowout preventer stack, a lower marine riser package, or located independently above the blowout preventer stack and lower marine riser package. The sensor systems described herein provide sensor coils, including a transmit coil and at least one receive coil embedded within a casing of the sensor system. The transmit coil, driven by a current pulse, generates an electromagnetic field within an interior space of the casing that interacts with the drilling pipe string as it transits through the casing, thereby generating perturbations of the electromagnetic field. The electromagnetic field, including the perturbations due to the drilling pipe string's interaction with the electromagnetic field, is detected by the receive coil and is processed to determine a diameter of the drilling pipe string proximate the receive coil. The diameter of the drilling pipe string is tracked over time. The time variability of the diameter of the drilling pipe string enables the detection by the sensor system of the presence of a pipe joint of the drilling pipe string within the casing. Detection of the location of the pipe joint enables the blowout preventer to operate more effectively in the event of a pressure increase in the well, as a shear-type blowout preventer may fail when shearing through a pipe joint. Knowledge of the location of a pipe joint enables the operator to move the drilling pipe string up or down to clear the shear ram from the pipe joint. The sensor systems described herein also provide position tracking and digital profiling of the drilling pipe string as it transits through the casing in which the sensor system is embedded.

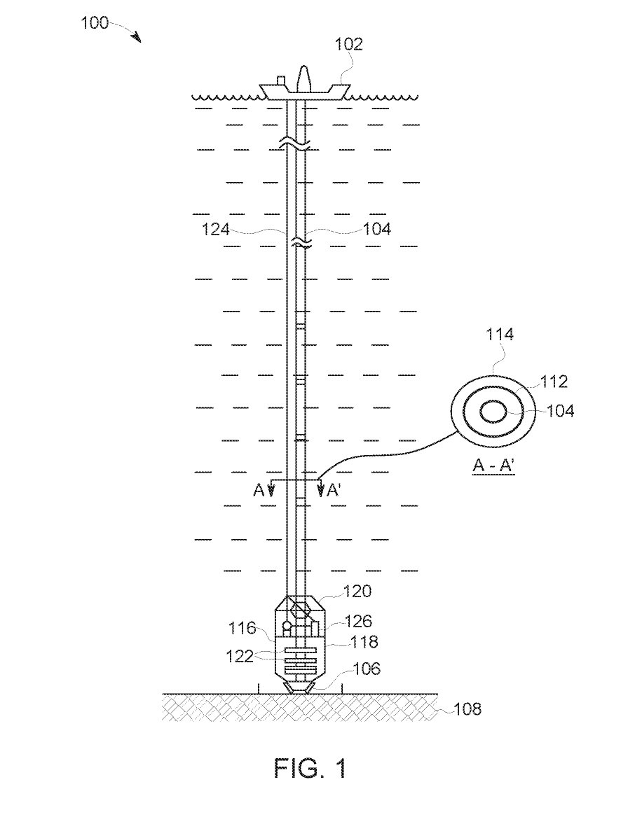

FIG. 1 is a schematic side view of an exemplary sub-sea oil and gas well 100. Oil and gas well 100 includes a platform 102 connected via a riser or drilling pipe string 104 to a wellhead 106 on the seabed 108. In alternative embodiments, platform 102 may be substituted for any other suitable vessel at the water surface.

Drilling pipe string 104, as illustrated in the cross-sectional view, comprises an end at which a drill bit (not shown) is rotated to extend the subsea well through layers below seabed 108. Mud is circulated from a mud tank (not shown) on drilling platform 102 through drilling pipe string 104 to the drill bit, and returned to drilling platform 102 through an annular space 112 between drilling pipe string and a protective casing 114 of drilling pipe string 104. The mud maintains a hydrostatic pressure to counter-balance the pressure of fluids produced from the well and cools the drill bit while also carrying crushed or cut rock to the surface through annular space 112. At the surface, the mud returning from the well is filtered to remove the rock and debris and is recirculated.

During drilling, gas, oil, or other well fluids at a high pressure may burst from the drilled formations into drilling pipe string 104 and may occur unpredictably. A blowout preventer stack 116 is disposed at or near seabed 108 to protect the well and equipment that may be damaged during such an event. Blowout preventer stack 116, sometimes referred to as the stack, may, in alternative embodiments, be located at different locations along drilling pipe string 104 according to requirements or specifications for certain offshore rigs. Blowout preventer stack 116 includes a lower stack 118 attached to wellhead 106, and a lower marine riser package (LMRP) 120 attached to a distal end of drilling pipe string 104. During drilling lower stack 118 and LMRP 120 are connected.

Lower stack 118 and LMRP include multiple blowout preventers 122 configured in an open state during normal operation. Blowout preventers 122 are configured to close to interrupt a fluid flow through drilling pipe string 104 when a pressure kick occurs. Oil and gas well 100 includes electrical cables or hydraulic lines 124 for communicating control signals from drilling platform 102 to a controller 126 located at blowout preventer stack 116. In alternative embodiments, controller 126 may be located remotely from blowout preventer stack 116 and communicatively coupled via a wired or wireless network. Controller 126 controls blowout preventers 122 to be in the open state or a closed state according to signals from drilling platform 102 communicated over electrical cables or hydraulic lines 124. Controller 126 also communicates information to drilling platform 102, including, for example, and without limitation, the current state of each blowout preventer 122, i.e., open or closed.

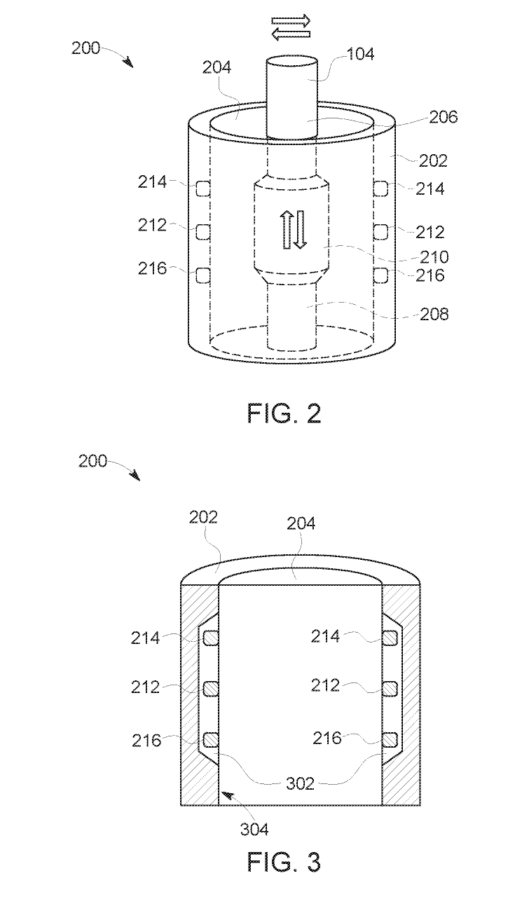

FIG. 2 is a schematic side view of an exemplary sensor system 200 for use in sub-sea oil and gas well 100 (shown in FIG. 1). Sensor system 200 includes a cylindrical casing 202 defining an interior space 204 within which drilling pipe string 104 transits. In alternative embodiments, sensor system 200 may utilize any other suitably-shaped casing with which to interface sub-sea oil and gas well 100. For, example, cylindrical casing 202 may be substituted for a rectangular casing. Referring again to FIG. 2, in certain embodiments, cylindrical casing 202 is located within sub-sea equipment, such as, for example, blowout preventer stack 116 (shown in FIG. 1). In alternative embodiments, cylindrical casing 202 is located above blowout preventer stack 116, within LMRP 120 (shown in FIG. 1), or otherwise independent of blowout preventers 122 (shown in FIG. 1). In certain embodiments, sensor system 200 is located at or near drilling platform 102 and is employed in combination with an additional installation of sensor system 200 at seabed 108. In such embodiments, sensor system 200 at drilling platform 102 may be utilized in generating a digital profile of a given pipe joint as sections of drilling pipe string 104 are joined at the surface. The digital profile enables sensor system 200 at seabed 108 to more precisely detect the presence of that pipe joint as it transits cylindrical casing 202 at seabed 108.

Cylindrical casing 202, in certain embodiments, has an adjustable length that is selected according to the length of drilling pipe string 104 that is to be monitored. Cylindrical casing 202, in certain embodiments, is of equal or greater length than blowout preventer stack 116. Cylindrical casing 202, in certain embodiments, is fabricated of a flexible material, such as, for example, elastomeric material, rubber fabric, or other suitable flexible material. In alternative embodiments, cylindrical casing 202 is fabricated from a rigid material placed along an outer surface of drilling pipe string 104 or along an inner surface of blowout preventer stack 116.

Drilling pipe string 104 includes an upper pipe section 206 and a lower pipe section 208 coupled together at a pipe joint 210. Pipe joint 210, notably, exhibits a larger diameter than respective diameters of upper pipe section 206 and lower pipe section 208. Drilling pipe string 104 translates vertically in an axial direction of cylindrical casing 202. Drilling pipe string 104 further translates laterally, or oscillates while the drilling pipe string rotates, in an orthogonal direction relative to the axial direction of cylindrical casing 202. Generally, lateral translation of drilling pipe string 104 and the presence of pipe joint 210 within interior space 204 affects the proximity of drilling pipe string 104 to the walls of cylindrical casing 202.

Sensor system 200 includes sensor coils, including a transmit coil 212 coupled to cylindrical casing 202. In one embodiment, transmit coil 212 includes a circumferential conductive coil. Transmit coil 212 conducts a current pulse that induces a corresponding electromagnetic field that interacts, e.g., electromagnetically couples, with drilling pipe string 104. The current pulse is, for example, and without limitation, a pair of periodic and square waves of opposite polarities. In one embodiment, the current pulse delivers approximately 0.5 watt of continuous power to transmit coil 212, at a duty cycle of approximately 10%. In such an embodiment, the current pulse itself delivers approximately five watts over its duration. In certain embodiments, the power available at the sub-sea location is limited. For example, an existing blowout preventer may have fewer than ten watts of continuous excess power. Consequently, in such embodiments, the efficiency with which the electromagnetic field is induced within interior space 204 is an important design consideration.

Sensor system 200 includes a first receive coil 214 coupled to cylindrical casing 202. In one embodiment, first receive coil 214 includes a circumferential conductive coil. First receive coil 214 is configured to detect the electromagnetic field that represents the corresponding electromagnetic field, induced by the current pulse, and perturbations of the electromagnetic field due to its interaction with drilling pipe string 104. In certain embodiments, sensor system 200 includes a second receive coil 216 coupled to cylindrical casing 202. Second receive coil 216 includes a circumferential conductive coil. Second receive coil 216 is configured to detect the electromagnetic field, including the perturbations, as well.

FIGS. 3-5 are schematic side views of exemplary arrangements of sensor coils within sensor system 200 (shown in FIG. 2). The arrangements illustrated in FIGS. 3-5 exhibit different performance, particularly with respect to the amount of current needed to conduct through transmit coil 212 to induce detectable electromagnetic fields within interior space 204 and with which drilling pipe string 104 can interact. For example, in certain embodiments, where transmit coil 212, first receive coil 214, and second receive coil 216 are located outside of cylindrical casing 202, the induced electromagnetic field must penetrate cylindrical casing 202 itself before radiating within interior space 204.

FIG. 3 illustrates transmit coil 212, first receive coil 214, and second receive coil 216 embedded within an insert 302 that itself is embedded within a void in an inner surface 304 of cylindrical casing 202. In certain embodiments, insert 302 is composed of the same or like-material as cylindrical casing 202, such as, for example, and without limitation, carbon steel. In alternative embodiments, insert 302 is composed of another material, such as, for example, and without limitation, titanium, stainless steel, or plastic polymer.

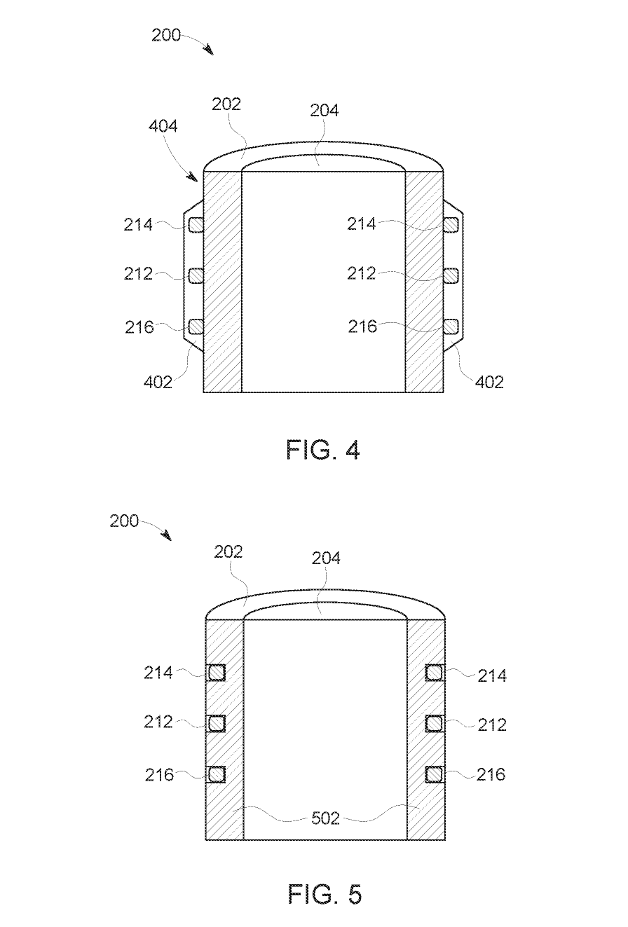

FIG. 4 illustrates transmit coil 212, first receive coil 214, and second receive coil 216 embedded within an insert 402 that is coupled to an outer surface 404 of cylindrical casing 202. In certain embodiments, insert 402 is composed of the same or like-material as cylindrical casing 202, such as, for example, and without limitation, carbon steel. In alternative embodiments, insert 402 is composed of another material, such as, for example, and without limitation, titanium, stainless steel, or plastic polymer.

FIG. 5 illustrates transmit coil 212, first receive coil 214, and second receive coil 216 embedded within a wall 502 of cylindrical casing 202 itself. Cylindrical casing 202 may be composed of, for example, and without limitation, carbon steel, a ferromagnetic metal, and a non-magnetic metal, such as, for example, aluminum, stainless steel, titanium, a polymer, or any combination thereof.

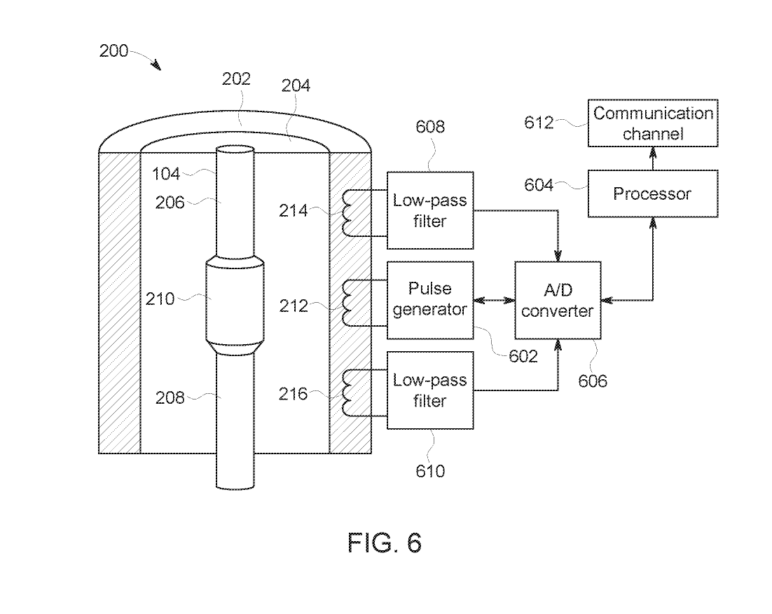

FIG. 6 is a schematic diagram of sensor system 200 (shown in FIG. 2). Sensor system 200 includes transmit coil 212, first receive coil 214, and second receive coil 216 coupled to cylindrical casing 202. Transmit coil 212 is electrically coupled to a pulse generator 602 configured to generate the current pulse conducted by transmit coil 212. In certain embodiments, pulse generator 602 is a configurable device, enabling adjustment of, for example, and without limitation, output power, current amplitude, voltage amplitude, and duty cycle.

Sensor system 200 includes a processor 604. Processor 604 is coupled to an analog/digital (A/D) converter 606. A/D converter 606 is a bi-directional device that converts analog signals to digital and digital signals to analog. In certain embodiments, processor 604 is configured to control pulse generator 602 through A/D converter 606. In such an embodiment, processor 604 transmits a digital control signal to A/D converter 606, where it is converted to an analog control signal and transmitted to pulse generator 602. In alternative embodiments, processor 604 controls pulse generator 602 directly using a digital control signal.

Sensor system 200 includes a first low-pass filter (LPF) 608 and a second LPF 610 respectively coupled to first receive coil 214 and second receive coil 216. The electromagnetic field corresponding to the current pulse conducted through transmit coil 212 interacts with drilling pipe string 104, which modifies the electromagnetic field. The resulting electromagnetic field includes perturbations of the electromagnetic field due to drilling pipe string 104's interaction with the electromagnetic field. The electromagnetic field induces a first current in first receive coil 214 and a second current in second receive coil 216. The first current represents the outer dimension of drilling pipe string 104 proximate first receive coil 214. The second current represents the outer dimension of drilling pipe string 104 proximate second receive coil 216. Generally, when pipe joint 210 passes through cylindrical casing 202, the outer dimension of drilling pipe string 104 increases and the respective voltage amplitudes of the first and second currents induced in first and second receive coils 214 and 216 are increased. LPF 608 and LPF 610 remove high frequency noise from the first and second current voltages before they are received at A/D converter 606, converted to digital voltage signals and transmitted to processor 604.

Processor 604 is configured to compute the diameter of drilling pipe string 104 based on the current pulse and the digital voltage signals representing the electromagnetic field detected by first and second receiver sensor coils 214 and 216. The signals correlate to a diameter of drilling pipe string 104. In one embodiment, processor 604 is configured to compute a parameter, S, according to EQ. 1, below, where S corresponds to the diameter of drilling pipe string 104 based on one of the first and second voltage signals, V, from first and second receive coils 214 and 216, and t represents time.

S=∫ₜ_{₁}^{t}^{₂}Vdt−∫ₜ_{₂}^{t}^{₃}Vdt EQ. 1

The diameter of drilling pipe string 104, as detected by sensor system 200, varies over time as numerous sections of drilling pipe string 104 and pipe joints 210 transit through cylindrical casing 202. Moreover, pipe joint 210 transits through the electromagnetic field induced by transmit coil 212. Accordingly, the electromagnetic field detected by first receive coil 214 varies over time with respect to the electromagnetic field detected by second receive coil 216, as transmit coil 212 and first and second receive coils 214 and 216 are each spaced by a separation distance along the axial direction of cylindrical casing 202. In certain embodiments, processor 604 computes a diameter based on a mathematical combination of the electromagnetic fields detect by first and second receiver sensor coils 214 and 216, including, for example, and without limitation, addition, subtraction, time shifting, scaling, or other suitable mathematical combinations.

Processor 604 is configured to track the parameter, S, over a period of time, facilitating the determination of the diameter of drilling pipe string 104 and detection of the presence of pipe joint 210 within cylindrical casing 202. In alternative embodiments, the determination of the diameter of drilling pipe string 104 enables detection of the presence of various other downhole apparatus including, for example, and without limitation, drill collars, stabilizers, centralizers, measurement devices, bits, baskets, and steering tools. Given the separation of first and second receive coils 214 and 216 in the axial direction, the detection of the presence of pipe joint 210 by first receive coil 214 may lead or lag, in time, the same detection by second receive coil 216 depending on the direction of transit of drilling pipe string 104, i.e., toward the surface versus toward seabed 108. For example, when drilling pipe string 104 transits toward seabed 108, the presence of pipe joint 210 would result in a temporary rise in the parameter, S, and the diameter of drilling pipe string 104 that corresponds with the current pulse conducted through transmit coil 212. Such a temporary rise would occur first in the voltage signal generated by first receive coil 214, and then later would occur in the voltage signal of second receive coil 216.

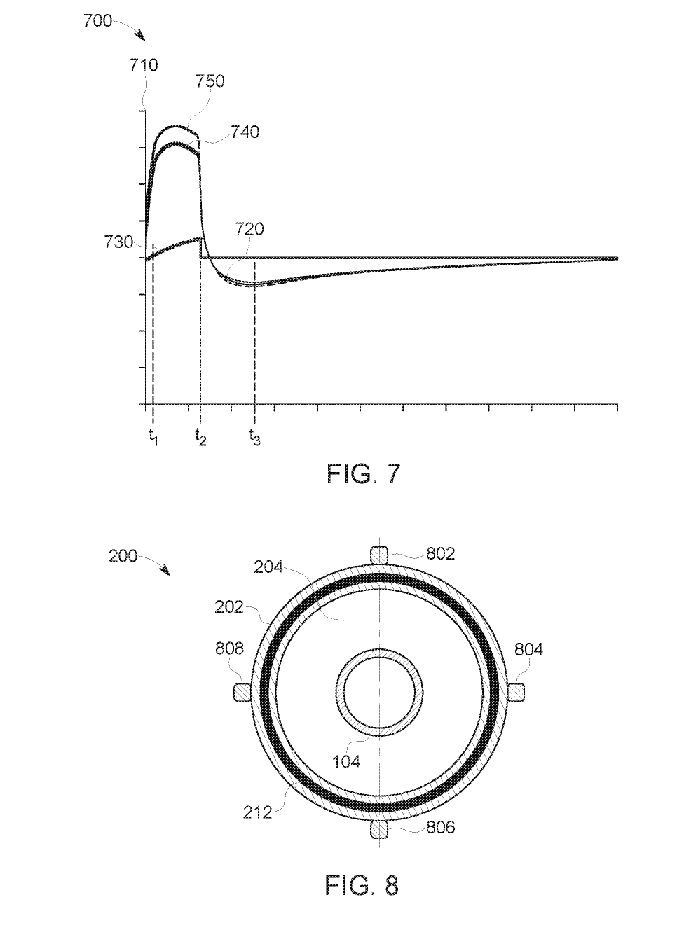

FIG. 7 is a plot 700 of voltage and current over time for sensor system 200 that illustrates the temporary rise in the parameter, S, that corresponds to pipe joint 210. Plot 700 includes a vertical axis 710 representing voltage and current amplitude. Plot 700 includes a horizontal axis 720 representing time over which sensor system 200 operates. Plot 700 illustrates a current pulse 730 having a duration from zero to t₂. A time, t₃, is illustrated on plot 700 for the purpose of the integration described in EQ. 1, where t₃−t₂=t₂−t₁. Plot 700 further illustrates a voltage signal 740 representing drilling pipe string 104, without pipe joint 210 being present, interacting with the electromagnetic field induced by current pulse 730 and being detecting by one of the first and second receive coils 214 and 216. Plot 700 further illustrates a voltage signal 750 representing drilling pipe string 104, with pipe joint 210 present and interacting with the electromagnetic field, and being detected by one of the first and second receive coils 214 and 216.

Referring again to FIG. 6, in certain embodiments, processor 604 is configured to apply a phase shift to the integration described in EQ. 1 to further reduce noise. In certain embodiments, pulse generator 602 is configured to generate a pair of current pulses having opposite polarity to reduce the effect of magnetic noise and residual magnetization of drilling pipe string 104. In certain embodiments, processor 604 is configured to apply a curve-fit to the computed parameter, S, of drilling pipe string 104 to cylindrical casing 202 to enhance detection of pipe joint 210. In an alternative embodiment, a differential signal is computed as a difference between parameter, S, for first and second receive coils 214 and 216 that is used to eliminate the effect of variations in the electromagnetic properties of the metal composing drilling pipe string 104.

Processor 604 is embedded with sensor system 200 at seabed 108. Processor 604 is coupled to a communication interface that communicatively couples processor 604 to drilling platform 102 through a communication channel 612 that enables communication of data from processor 604 to drilling platform 102. Communication channel 612, in certain embodiments, includes, for example, and without limitation, a powerline channel, an Ethernet channel, a serial channel, an optical fiber channel, or any other means for communication suitable for carrying data from seabed 108 to drilling platform 102. The communication interface includes, for example, and without limitation, a processor, a driver, a microcontroller, or other processing circuit for translating data from processor 604 onto communication channel 612. In one embodiment, processor 604 is configured to compute the parameter, S, as an integer, e.g., a 16 bit integer, and to transmit the integer over communication channel 612. In certain embodiments, such a transmission is made periodically, for example, approximately every 200 milliseconds. In other embodiments, the frequency at which the transmission is made, and the data representation of the computed parameter may vary to meet specific requirements of sub-sea oil and gas well 100. Communication channel 612, in certain embodiments, may be an existing data channel for sub-sea oil and gas well 100 or, more specifically, for blowout preventer stack 116.

In alternative embodiments, processor 604 may be located at drilling platform 102. In such an embodiment, the sub-sea components of sensor system 200 package the digital voltage signals into a message that is transmitted onto communication channel 612 before the digital voltage signals are processed and the parameter, S, is computed.

FIG. 8 is a schematic cross-sectional view of one embodiment of sensor system 200 (shown in FIGS. 2 and 6). In the embodiment of FIG. 8, sensor system 200 includes an array of solid state sensors 802, 804, 806, and 808 coupled to cylindrical casing 202. Sensors 802, 804, 806, and 808 track the position of drilling pipe string 104 within cylindrical casing 202. In such embodiments, processor 604 (shown in FIG. 6) is coupled to sensors 802, 804, 806, and 808, and is configured to use the position tracking of drilling pipe string 104 to enhance the detection of pipe joint 210 by compensating for lateral movement of drilling pipe string 104 when processing the voltage signals from first and second receive coils 214 and 216 to compute and track the diameter of drilling pipe string 104 to cylindrical casing 202 over time. For example, as drilling pipe string 104 moves laterally toward solid state sensor 804, solid state sensor 804 detects drilling pipe string 104 moving nearer, and solid state sensor 808 detects drilling pipe string 104 moving correspondingly away. Such movement of drilling pipe string 104, under certain circumstances, introduces noise to the currents induced in first and second receive coils 214 and 216 by the electromagnetic field. Processor 604, by tracking the position of drilling pipe string 104, mitigates the noise and can cancel-out at least a portion of the noise exhibited in the voltage signals generated by first and second receive coils 214 and 216. In alternative embodiments, sensor system 200 may include fewer solid state sensors or, in other embodiments, more solid state sensors for tracking the position of drilling pipe string 104.

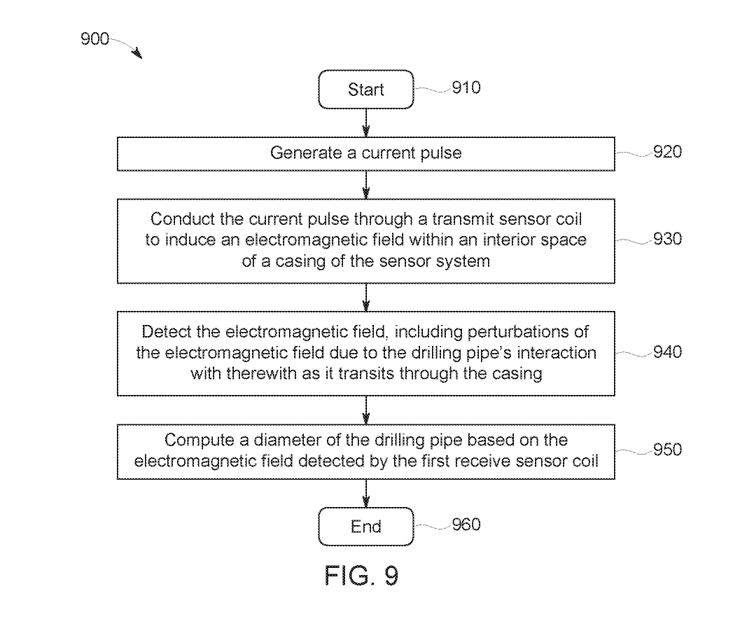

FIG. 9 is a flow diagram of an exemplary method 900 of operating sensor system 200 (shown in FIGS. 2 and 6). Method 900 begins at a start step 910. At a generation step 920, a current pulse is generated at a pulse generator 602. Pulse generator 602 transmits the current pulse into transmit coil 212, which conducts 930 the current pulse to induce an electromagnetic field within interior space 204 of casing 202 of sensor system 200.

As sub-sea oil and gas well 100 operates, drilling pipe string 104 transits through casing 202 of sensor system 200, which is located, for example, and without limitation, at seabed 108 within blowout preventer stack 116, interacts with the electromagnetic field induced at conducting step 930. Drilling pipe string 104 includes pipe joint 210, which joins upper pipe section 206 and lower pipe section 208, each of which interacts uniquely and time-variably with the electromagnetic field. First receive coil 214 detects 940 the electromagnetic field, including perturbations of the electromagnetic field due to its interaction with drilling pipe string 104. During detection 940, a current is induced in first receive coil 214 that generates an analog voltage signal. The analog voltage signal is filtered by LPF 608 and converted by A/D converter 606 to a digital voltage signal that is received by processor 604. Processor 604 computes 950 a diameter of drilling pipe string 104 based on the electromagnetic field detected by first receive coil 214.

The above described sensor systems provide a sensor system for detecting and tracking pipe joints in a drilling pipe string for a sub-sea oil and gas well. The sensor systems described herein may be embodied within a blowout preventer, a blowout preventer stack, a lower marine riser package, or located independently above the blowout preventer stack and lower marine riser package. The sensor systems described herein provide a transmit and receive coils embedded within a casing of the sensor system. The transmit coil, driven by a current pulse, generates an electromagnetic field that within an interior space of the casing that interacts with the drilling pipe string as it transits through the casing. The electromagnetic field, including perturbations of the electromagnetic field due to its interaction with the drilling pipe string is detected by the receive coil and is processed to determine a diameter of the drilling pipe string proximate the receive coils based on a computed parameter, S. The diameter of the drilling pipe string is tracked over time. The time variability of the diameter of the drilling pipe string enables the detection by the sensor system of the presence of a pipe joint of the drilling pipe string within the casing. Detection of the presence of the pipe joint enables the blowout preventer to operate more effectively in the event of a pressure increase in the well, as a shear-type blowout preventer may underperform when shearing through a pipe joint. The sensor systems described herein also provide position tracking and digital profiling of the pipe joints in the drilling pipe string as it transits through the casing in which the sensor system is embedded.

An exemplary technical effect of the methods, systems, and apparatus described herein includes at least one of: (a) improving reliability of pipe joint position sensing; (b) reducing power consumption of pipe joint position sensing; (c) improving operating life of pipe joint position sensing; (d) reducing impact of drilling pipe string axial shift in pipe joint position sensing; (e) improving sensor system self-monitoring of health; (f) tracking axial position of drilling pipe string; (g) improving operation of shear-type blowout preventers through detection of pipe joints; and (h) improving reliability of blowout preventers.

Exemplary embodiments of methods, systems, and apparatus for sensor systems are not limited to the specific embodiments described herein, but rather, components of systems and/or steps of the methods may be utilized independently and separately from other components and/or steps described herein. For example, the methods may also be used in combination with other non-conventional sensor systems, and are not limited to practice with only the systems and methods as described herein. Rather, the exemplary embodiment can be implemented and utilized in connection with many other applications, equipment, and systems that may benefit from increased reliability and availability, and reduced maintenance and cost.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A sensor system for a sub-sea oil and gas well, said sensor system comprising:
a casing defining an interior space through which a drilling pipe string transits;
a transmit coil coupled to said casing, said transmit coil configured to conduct a current pulse and induce an electromagnetic field, corresponding with the current pulse, within the interior space and with which the drilling pipe string interacts;
a first receive coil coupled to said casing, said first receive coil configured to detect the electromagnetic field, including perturbations of the electromagnetic field due to the drilling pipe string's interaction with the electromagnetic field; and
a processor coupled to said transmit coil and said first receive coil, said processor configured to compute a diameter of the drilling pipe string based on the current pulse and the electromagnetic field detected by said first receive coil.

2. The sensor system in accordance with claim 1, wherein said first receive coil is separated from said transmit coil by a separation distance in an axial direction of said casing.

3. The sensor system in accordance with claim 1 further comprising a second receive coil coupled to said processor, said second receive coil configured to detect the electromagnetic field, including the perturbations of the electromagnetic field due to the drilling pipe string's interaction with the electromagnetic field, said processor further configured to compute the diameter of the drilling pipe string proximate said second receive coil based on the electromagnetic field detected by said first receive coil and said second receive coil.

4. The sensor system in accordance with claim 1, wherein said processor is further configured to track the diameter of the drilling pipe string proximate said first receive coil over a period of time.

5. The sensor system in accordance with claim 4, wherein said processor is further configured to detect a presence of a pipe joint of the drilling pipe string within the interior space based on a change in the diameter of the drilling pipe string over the period of time.

6. The sensor system in accordance with claim 5 further comprising an array of solid state sensors coupled to said casing, said array of solid state sensors configured to track axial position of the drilling pipe string within the interior space to detect lateral translation.

7. The sensor system in accordance with claim 6, wherein said processor is further configured to enhance detection of the presence of the pipe joint based on the lateral translation of the drilling pipe string detected by said array of solid state sensors.

8. The sensor system in accordance with claim 7, wherein said processor is further configured to generate a digital profile of the drilling pipe string based on the diameter tracked over the period of time.

9. The sensor system in accordance with claim 4, wherein said processor is further configured to detect a presence of a drill collar on the drilling pipe string within the interior space based on a change in the diameter of the drilling pipe string over the period of time.

10. The sensor system in accordance with claim 1, wherein said casing comprises a wall, and wherein said first receive coil and said transmit coil are disposed within said wall.

11. The sensor system in accordance with claim 10, wherein said wall comprises a ferromagnetic metal.

12. The sensor system in accordance with claim 1, wherein said casing comprises a wall having an outer surface, and wherein said first receive coil and said transmit coil are disposed on said outer surface of said wall.

13. A sub-sea blowout preventer comprising:
a cylindrical casing defining an interior space through which a drilling pipe string transits;
a communication interface configured to be communicatively coupled to a drilling platform through a communication channel; and
a sensor system comprising:
a transmit coil coupled to said cylindrical casing, said transmit coil configured to periodically generate an electromagnetic field within the interior space and with which the drilling pipe string interacts;
a first receive coil coupled to said cylindrical casing, said first receive coil configured to detect the electromagnetic field, including perturbations of the electromagnetic field due to the drilling pipe string's interaction with the electromagnetic field; and
a processor coupled to said communication interface, said transmit coil, and said first receive coil, said processor configured to track a diameter of the drilling pipe string based on the electromagnetic field detected by said first receive coil, and transmit data representing the diameter onto the communication channel through said communication interface.

14. The sub-sea blowout preventer in accordance with claim 13 further comprising a pulse generator coupled to said transmit coil, said pulse generator configured to periodically generate a current pulse corresponding to the electromagnetic field.

15. The sub-sea blowout preventer in accordance with claim 13 further comprising a low-pass filter (LPF) coupled between said first receive coil and said processor, said LPF configured to reduce noise in an analog signal induced in said first receive coil by the electromagnetic field.

16. The sub-sea blowout preventer in accordance with claim 14 further comprising an analog to digital converter coupled between said LPF and said processor, said analog to digital converter configured to convert the analog signal from said LPF to a digital voltage signal utilized at said processor.

17. A method of operating a sensor system at a sub-sea oil and gas well, said method comprising:
generating a current pulse;
conducting the current pulse through a transmit coil to induce an electromagnetic field within an interior space of a casing of the sensor system;
detecting, at a first receive coil, the electromagnetic field, including perturbations of the electromagnetic field due to the interaction of a drilling pipe string with the electromagnetic field as it transits through the casing; and
computing a diameter of the drilling pipe string based on the electromagnetic field detected by the first receive coil.

18. The method in accordance with claim 17 further comprising tracking the diameter of the drilling pipe string over time.

19. The method in accordance with claim 18 further comprising detecting a presence of a pipe joint of the drilling pipe string based on the diameter tracked over time.

20. The method in accordance with claim 19 further comprising applying a curve-fit to the electromagnetic field detected by the first receive coil tracked over time to improve detection of the diameter of the pipe joint.

21. The method in accordance with claim 17 further comprising transmitting data representing the diameter from the sub-sea oil and gas well to a drilling platform.

22. The method in accordance with claim 17 further comprising tracking an axial position of the drilling pipe string within the casing.
